(19) United States
(12) Patent Application Publication
(10) Pub. No.: US 2008/0055453 A1
(43) Pub. Date: Mar. 6, 2008

(54) Displaying a live view and captured images in a digital camera

(76) Inventors: Amy E. Battles, Fort Collins, CO (US); Sarah J. Schwartz, Fort Collins, CO (US); Geoffrey Dowd, San Francisco, CA (US); Ben Fineman, San Francisco, CA (US); Cordell Ratzlaff, Palo Alto, CA (US); Karen E. Williams, Fort Collins, CO (US); James Comer, Fort Collins, CO (US); Benjamin D. Kimbell, Fort Collins, CO (US); Angelica A. Quintana, Rio Rancho, NM (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/516,100

(22) Filed: Sep. 5, 2006

(51) Int. Cl. H04N 5/222; G03B 13/02; G06F 3/048

(52) U.S. Cl. 348/333.05; 348/36; 396/374; 715/838

(57) ABSTRACT

A method for displaying a live view and captured images of a digital camera is provided. In the method, a live view is displayed. A first image of the live view is captured. In response to capturing the first image, the captured first image is displayed. The captured first image is then shifted from view toward a first direction to reveal the live view.

### BACKGROUND

After years of continual improvement and refinement, digital cameras now provide an attractive alternative to photographic film cameras, due to their affordability, ease of use, advanced resolution, large image storage capability, and other factors. Nevertheless, due to increasing competition between digital camera manufacturers, the process of improving upon current digital camera offerings continues unabated. Any potential advantage provided by a digital camera over the competition for the benefit of the customer can mean augmented sales, and hence additional revenue, for the manufacturer.

One particular facet of digital cameras often targeted for improvement is the interface between the camera and a user of the camera. Due to the relative complexity of digital cameras, camera designers often attempt to make the user interface friendlier, thus potentially rendering operation of the camera easier for the user.

A highly-used area of digital camera operation sensitive to the design of the user interface is the display of a “live view” and previously captured images. Generally, the live view is the view provided to a user on a display as perceived by the imaging system of the camera, and is thus instrumental in providing the user with the ability to frame a scene for subsequent capture. Typically, the user may manipulate the user interface of the camera by way of buttons, dials and the like to control the display to view any of a number of captured images or the live view. However, switching use of the display between the live view and the captured images, or between one captured image and another, is often difficult and unintuitive, thus providing a potential source of frustration for the user.

### BRIEF DESCRIPTION OF THE DRAWINGS

FIG. 1 is flow diagram of a method for displaying a live view and captured images of a digital camera according to an embodiment of the invention.

FIG. 2 is a block diagram of a digital camera according to an embodiment of the invention.

FIG. 3 is perspective diagram primarily depicting the user interface of a digital camera according to another embodiment of the invention.

FIG. 4 is a flow diagram of a method for displaying a live view and captured images of a digital camera according to another embodiment of the invention.

FIGS. 5A through 5P are diagrams describing the appearance of a live view and captured images on a display of a digital camera according to an embodiment of the invention.

### DETAILED DESCRIPTION

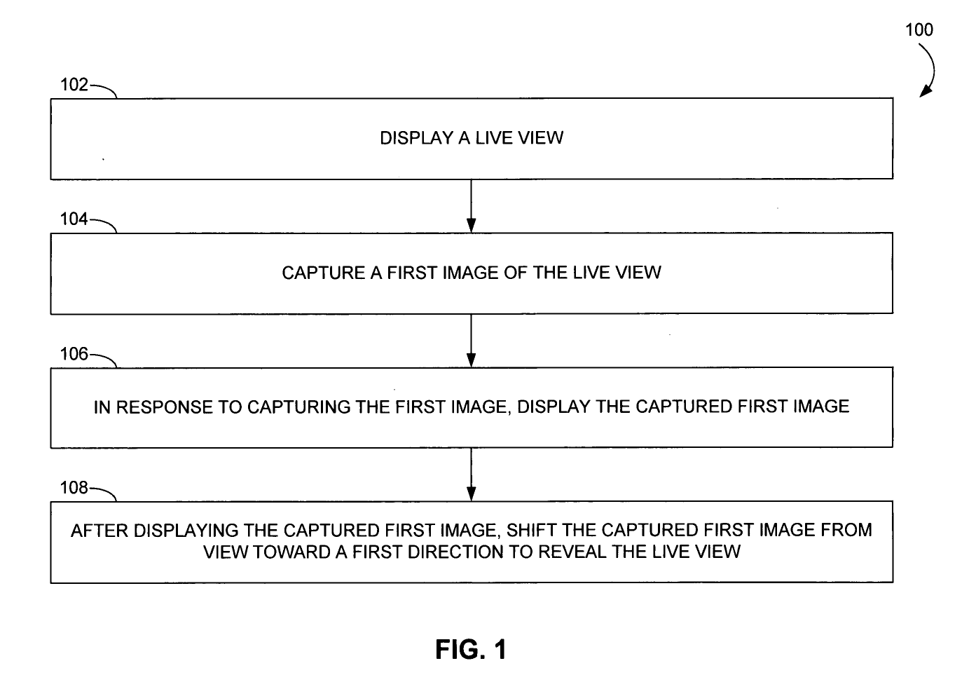

A method 100 for displaying a live view and captured images of a digital camera is illustrated in FIG. 1. The live view is displayed (operation 102). As described earlier, “live view” is the current view of a scene as perceived by an imaging system of the camera. A first image of the live view is then captured (operation 104). In response to capturing the first image, the captured first image is displayed (operation 106). After the first image is displayed, the captured first image is then shifted from view toward a first direction to reveal the live view (operation 108).

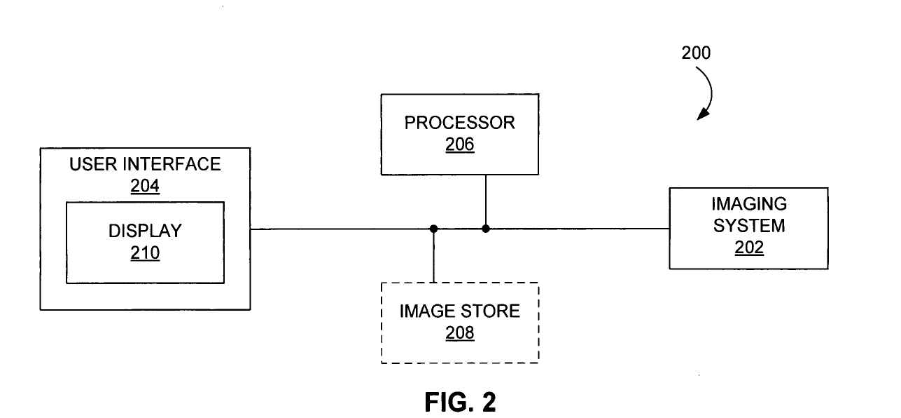

Another embodiment of the invention is a digital camera 200, shown in FIG. 2. The camera 200 includes an imaging system 202, a user interface 204, and a processor 206. Optionally, the camera 200 may include an image store 208. The imaging system 202 is configured to provide a live view, and to capture images of the live view. The user interface 204 comprises a display 210 configured to present the live view and the captured images to a user. The processor 206 is configured to display the live view via the display 210 and capture a first image of the live view via the imaging system 202. In response to capturing the first image, the processor 206 is configured to display the captured first image on the display 210. The captured first image is then shifted toward a first direction off of the display 210 to reveal the live view.

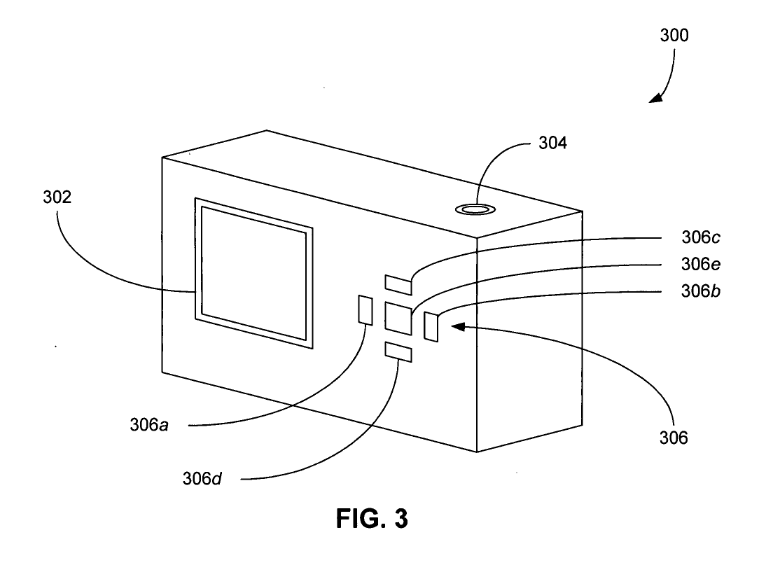

Another embodiment of a camera 300 according to another embodiment of the invention is illustrated in the perspective diagram of FIG. 3, which exemplifies several possible structures included in a user interface similar to the user interface 204 of FIG. 2. More specifically, the user interface of FIG. 3 includes a display 302, as well as an input section including an image storage button 304 and a five-button input-selection group 306. In addition, the camera 300 also includes the various components shown in FIG. 2 for the camera 200, such as the imaging system 202 and the processor 206.

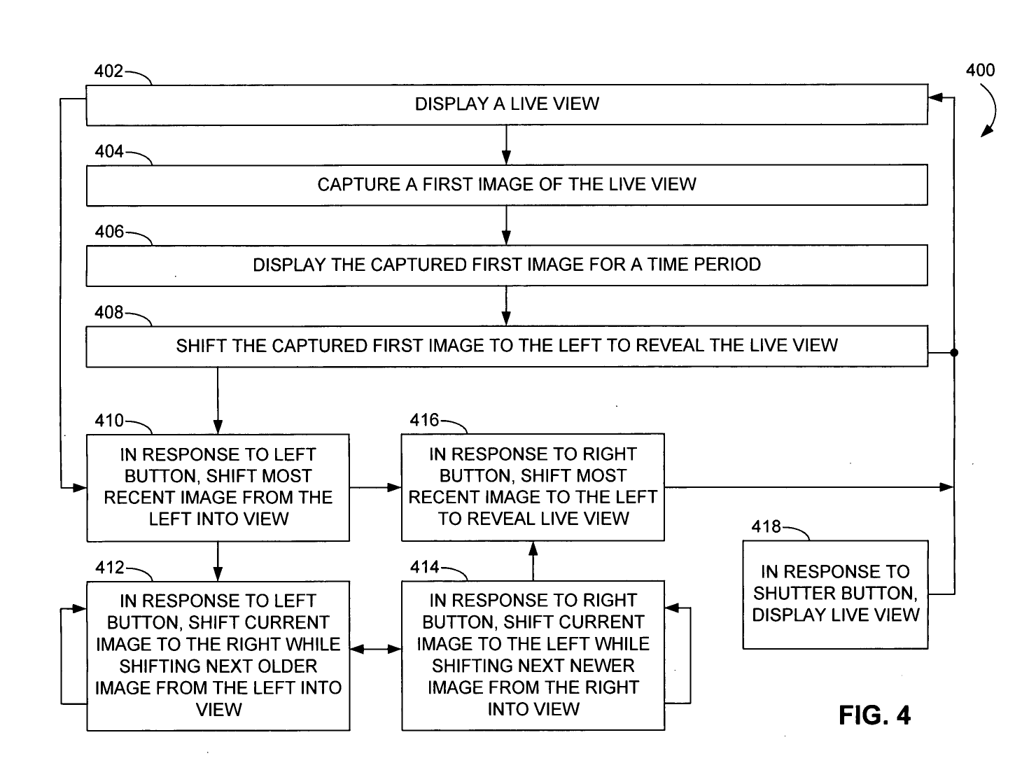

Additionally, FIG. 4 graphically illustrates a method 400 for displaying a live view and captured images of a digital camera. Below, the method 400 is explained in conjunction with the description of the camera 300 provided below. However, the method 400 may be employed by cameras other than the camera 300 of FIG. 3 in other embodiments.

In one particular example, the display 302 of the camera 300 is a color liquid crystal display (LCD) allowing the user to view current and stored images, to view menus or parameters for controlling the operation of the camera 300, and the like. Other displays, such as monochrome LCDs, may be employed in other embodiments.

In one embodiment, the camera 300 is a digital still camera capable of continuously presenting a field of view for presentation to the user by way of the display 302 without actually storing the images. In one example, this mode is termed “live view,” as described above. The field of view is the viewable area of a scene represented by the image shown on the display 302. During live view, the user may cause the camera 300 to store one or more images appearing within the field of view of the display 302 into digital memory, such as the image store 208 of FIG. 2. The image store 208 may include one or more memory devices permanently residing within the camera 300. In other cases, the image store 208 may be a replaceable memory card such as a Secure Digital (SD) card. Typically, the user initiates the storing of an image by way of the image storage button 304, or “shutter button” 304, of FIG. 3.

The five-button group 306 may be employed by the user to navigate menus, select menu items, and accomplish other tasks to configure the camera 300 according to the needs of the user. The four outer buttons (left directional button 306a, right directional button 306b, up directional button 306c, and down directional button 306d) of the five-button group 306 are often used for menu navigations, numeric value selection, and the like, while the center button 306e may be employed to select a particular menu item, traverse various levels of a menu, and so on.

With respect to embodiments of the present invention, the shutter button 304 and the buttons of the five-button group 306, and particularly the left directional button 306a and the right directional button 306b, may be employed to view the live view and the captured images of the camera 300, as described in greater detail hereinafter.

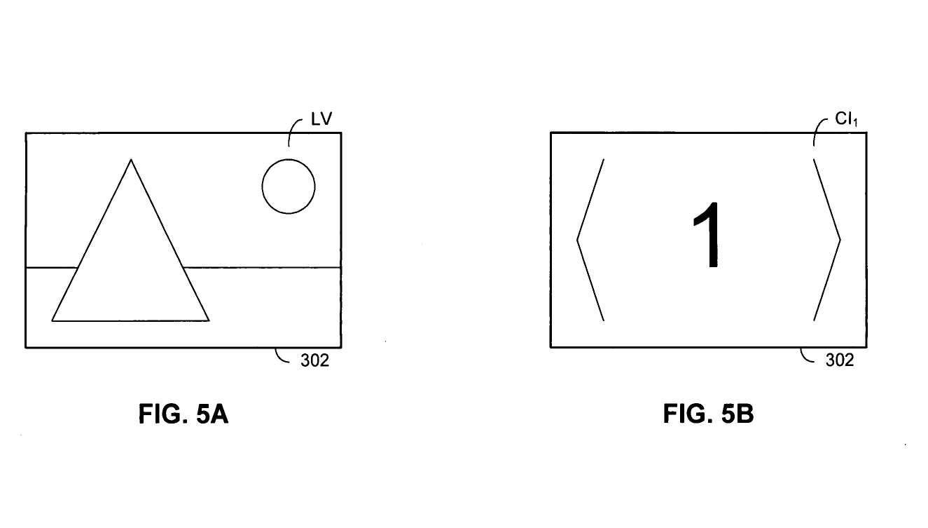

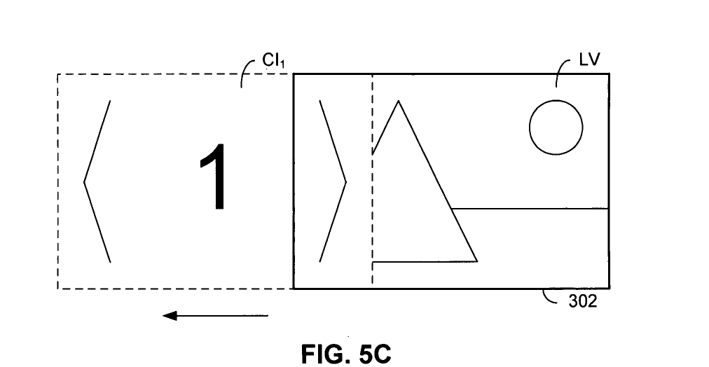

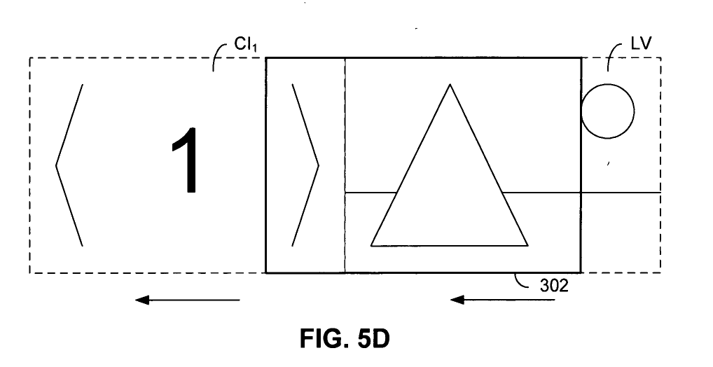

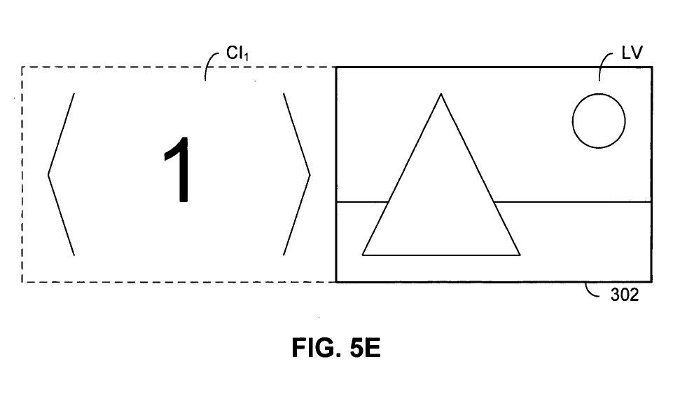

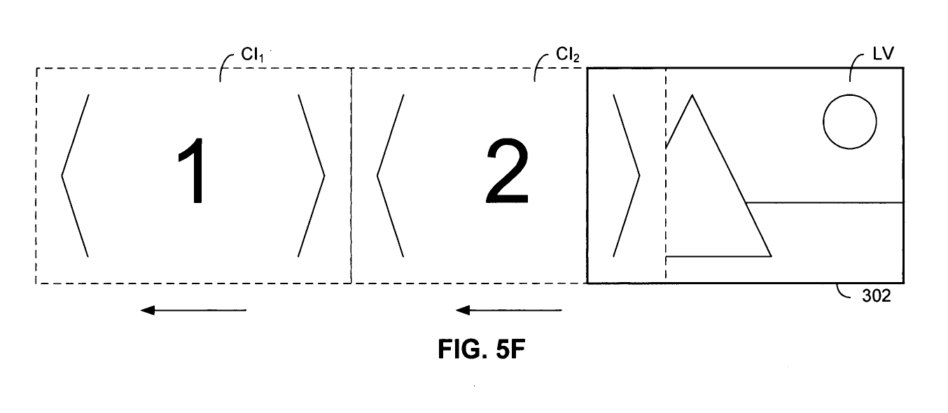

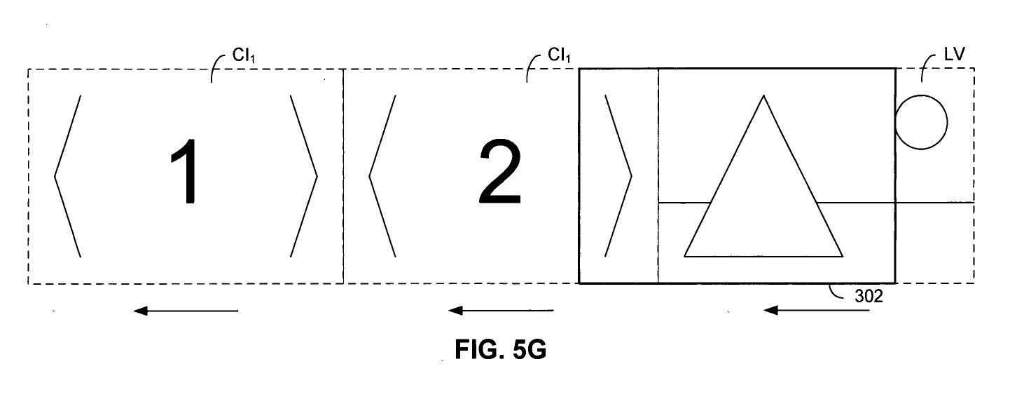

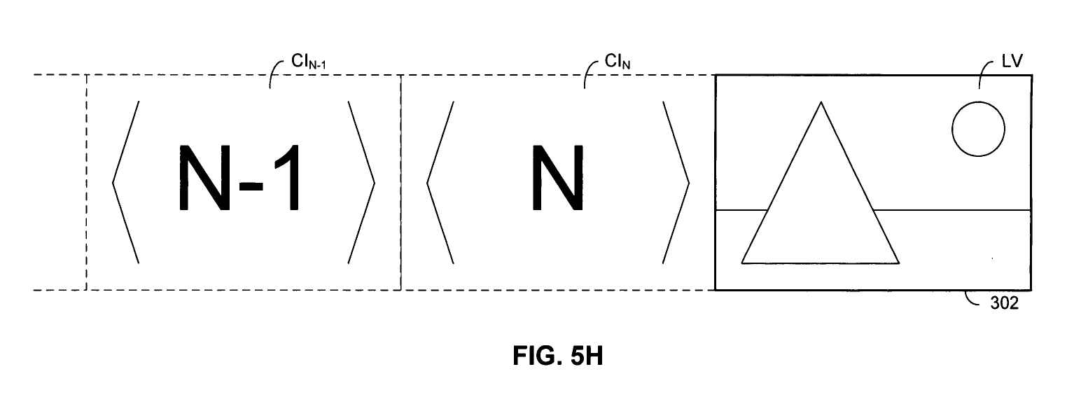

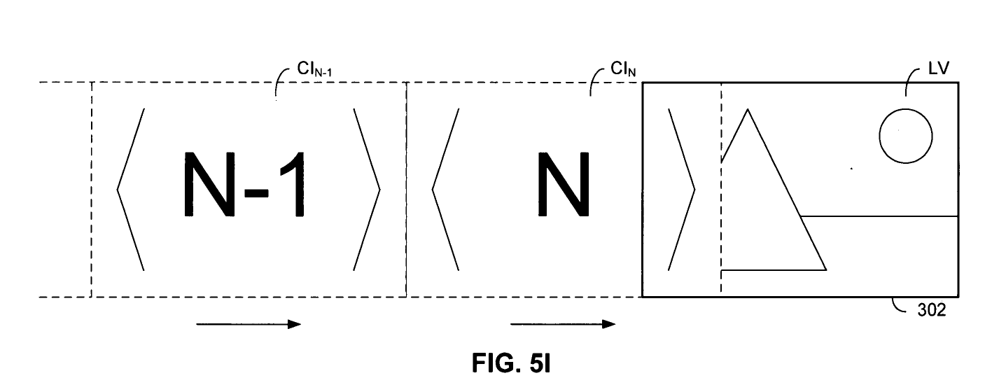

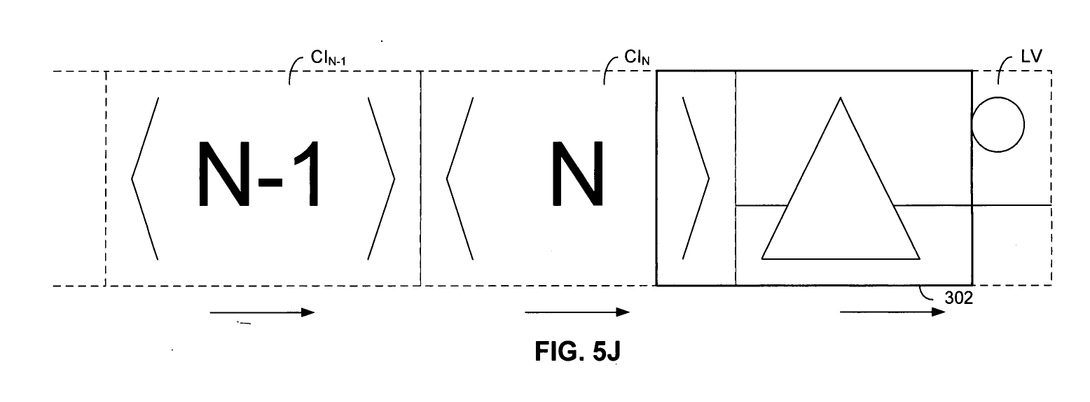

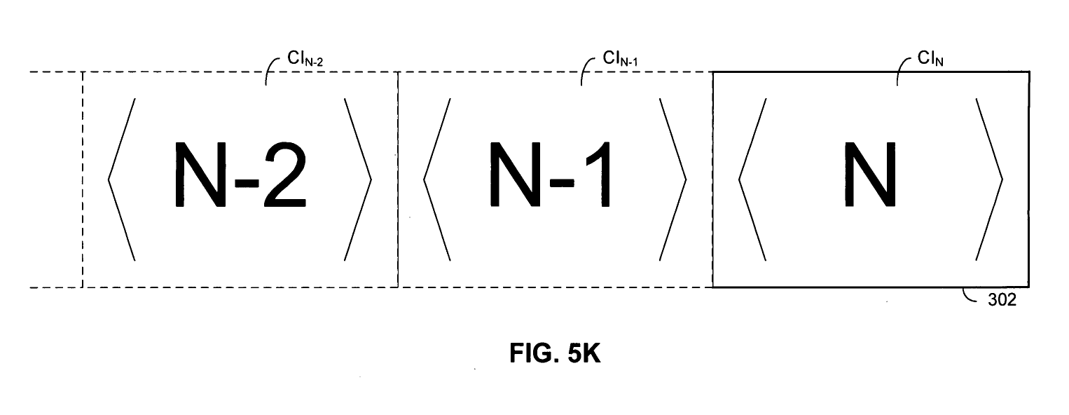

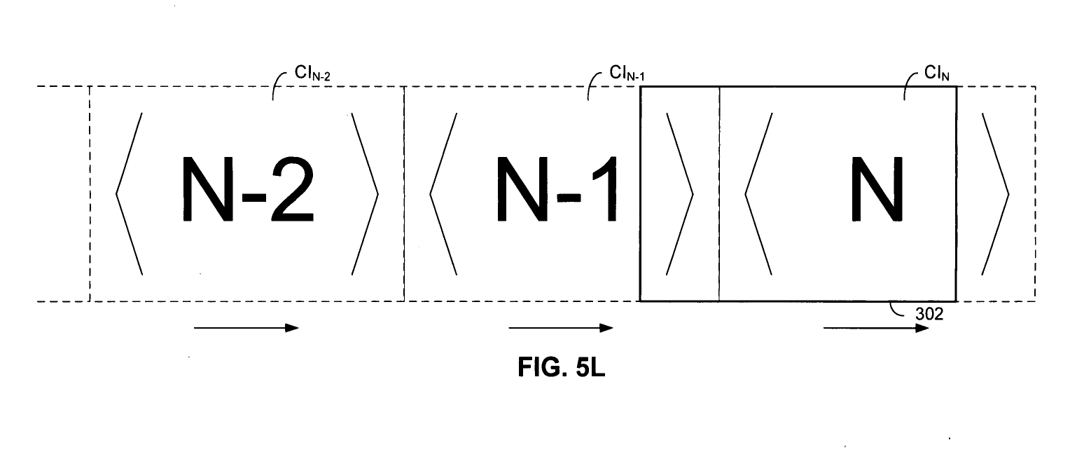

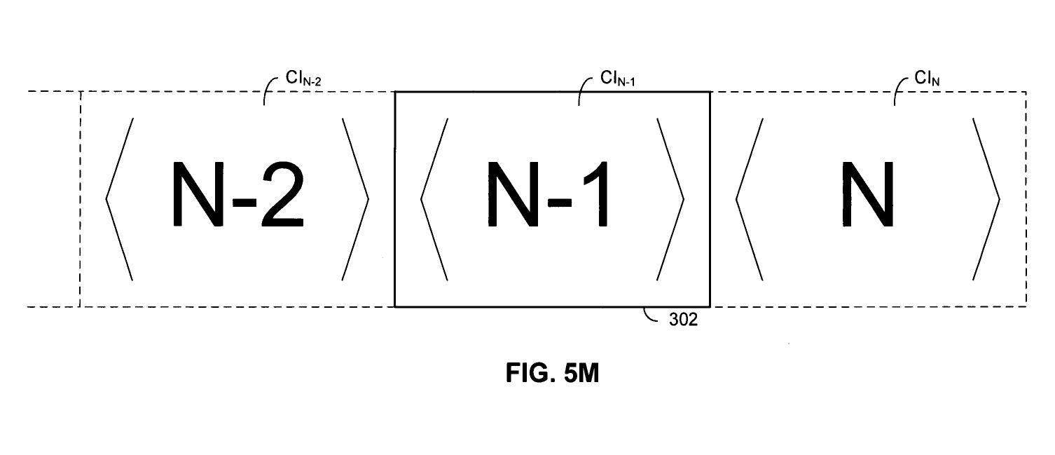

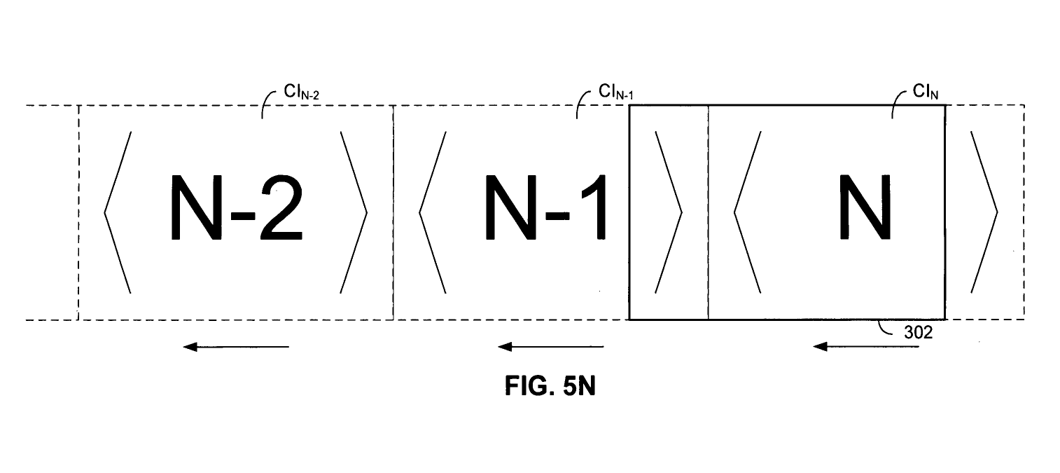

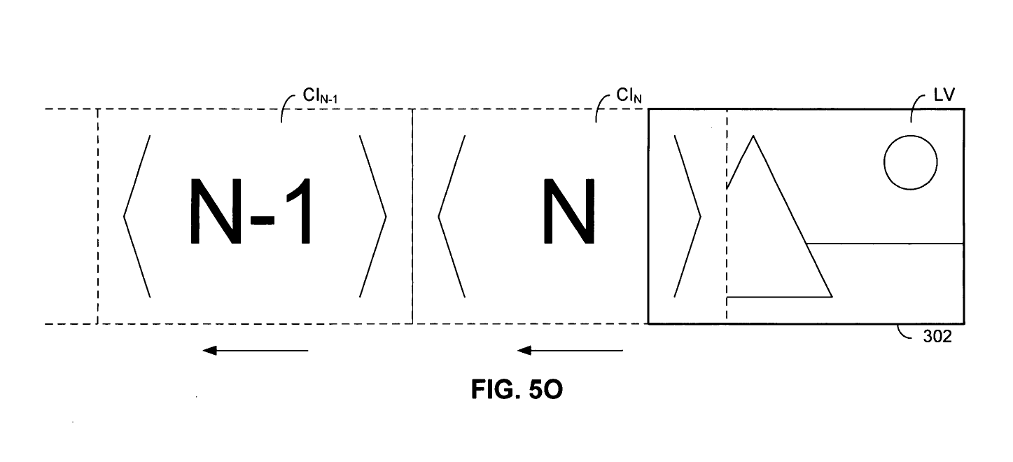

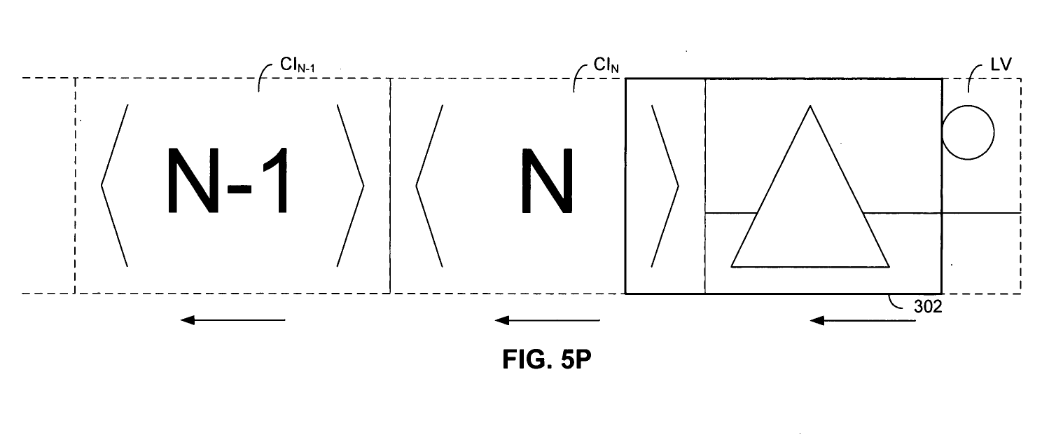

FIG. 5A depicts a possible live view LV of a scene as presented on the display 302 of the camera 300. This same depiction of live view LV is employed in many of FIGS. 5A-5P to facilitate understanding of how the live view LV and the various captured images are presented to a user of the camera 300.

While the live view LV is being provided on the display 302 (operation 402 of FIG. 4), the user may wish to capture the live view LV as an image (operation 404). In one example, the user depresses the shutter button 304 of the camera 300 to cause the image of the live view LV to be captured by way of the imaging system 202. Optionally, this and other captured images may be stored in the image store 208, described above. This first captured image CI₁ is thus presented on the display 302 for review by the user, as shown in FIG. 5B, thus temporarily replacing the live view LV. In FIG. 5B and thereafter, captured images are denoted by way of the designation CI and a subscript number, such as 1, 2, . . . , N-1, and N, thus indicating the order in which a series of images have been captured, beginning with the first or oldest.

After the first captured image (or, alternately, the captured first image) CI₁ is displayed for a period of time (operation 406), such as, for example, two or three seconds, the first captured image CI₁ is shifted from the display 302 in a first direction to reveal the live view LV (operation 408), as shown in FIG. 5C. In the specific example of FIG. 5C, the first direction is to the left from the perspective of the user. In other embodiments, another direction, such as right, up or down, may be employed for shifting the first and subsequent captured images CI. In “revealing” the live view LV as shown in FIG. 5C, the live view LV may appear stationary, or locked in place, within the display 302 while the first captured image CI₁ is shifted toward the left, thus revealing the live view LV beginning with the right-hand side of the live view LV. In another embodiment shown in FIG. 5D, revealing the live view LV involves shifting the live view LV from the right onto the display 302 while the first captured image CI₁ is shifted toward the left. Shorter or longer time periods other than two or three seconds for displaying a captured image CI may be employed in other embodiments. The time period may be user-programmable in one embodiment. Also, in one implementation, the shift of the first captured image CI₁ may occur immediately after the first captured image CI₁ is first displayed, resulting in a time period of zero. In yet another implementation, the time period may be effectively infinite, resulting in the first captured image CI₁ continuing to be shown on the display 302 until a user action, such as the depression of a button of the five-button group 306, causes the first captured image CI₁ be shifted from the display 302. In FIG. 5C and the following figures, any portion of the captured images CI or the live view LV shifted to or from the display 302 is shown in a dashed outline form to provide a conceptual context for retrieving the various captured images CI.

After the shifting of the first captured image CI₁ to the left is complete, the presentation of the live view LV on the display 302 remains essentially unimpeded by the first captured image CI₁, as shown in FIG. 5E. Conceptually, the first captured image CI₁ remains to the left of the display 302 for retrieval, as is described below.

A second captured image CI₂ of the live view LV may also be captured, displayed for a period of time, and then shifted to the left in the same manner as the first captured image CI₁ (repeating operations 402-408). FIGS. 5F and 5G illustrate the second captured image CI₂ being shifted from the display 302, with the first captured image CI₁ conceptually being shifted further left. The embodiment of FIG. 5F shows the live view LV appearing static within the display 302 as the second captured image CI₂ shifts to the left, while the embodiment of FIG. 5G depicts the live view LV being shifted onto the display 302 from the right as the second captured image CI₂ shifts to the left.

After several images CI₁ through CI_{N} have been captured and shifted from the display 302, the current live view LV as presented by the imaging system 202 remains on the display 302, as depicted in FIG. 5H. From a conceptual standpoint, each of the captured images CI₁-CI_{N} reside in order off to the left, beginning from the display 302 with the most recently captured image CI_{N}, and progressing to the left toward the first and oldest captured image CI₁.

After capturing one or more images CI, the user of the camera 300 may wish to review one or more of the images CI using the display 302. Given the conceptual positioning of the captured images CI₁-CI_{N} to the left of the display 302, as shown in FIG. 5H, the camera 300 is configured to provide an intuitive interface for the user to retrieve the images CI₁-CI_{N}. More specifically, the user interface may allow the user to retrieve the most recently captured image CI_{N} by depressing the left directional button 306a of FIG. 3. In response, the processor 206 may cause the most recently captured image CI_{N} to shift from the left toward the right onto the display 302, thus removing the live view LV from the display 302 (operation 410). FIG. 5I illustrates the shifting of the most recently captured image CI_{N} over the live view LV, while FIG. 5J depicts another embodiment in which the live view LV is shifted toward the right as the most recently captured image CI_{N} is shifted in from the left. In either case, FIG. 5K shows the display 302 showing the most recently captured image CI_{N} after the shifting is complete.

Presuming the user would like to view the next most recently captured image CI_{N-1}, the user may depress the left directional button 306a once more. In response, the processor 206, employing the display 302, shifts the most recently captured image CI_{N} toward the right and out of view while shifting the next most recently captured image CI_{N-1} in from the left and into view on the display 302 (operation 412). This shifting is shown in progress in FIG. 5L. After the shifting is complete, the next most recently captured image CI_{N-1} is presented on the display 302, as illustrated in FIG. 5M. Intuitively, the most recently captured image CI_{N} is located to the right of the display 302, while the remaining captured images CI₁-CI_{N-2} are positioned in order to the left.

Continuing in this fashion, the user may review any of the captured images CI, older or newer, by employing the left directional button 306a and the right directional button 306b. More specifically, when the user depresses the left directional button 306a, the currently viewed captured image is shifted toward the right while the next older captured image is shifted from the left onto the display 302 (again, operation 412). In the case the live view LV is shown on the display 302, the most recently captured image CI_{N} is shifted from the left onto the display 302 (operation 410), as shown graphically in FIGS. 5I and 5J. If the currently displayed image is the oldest captured image CI₁, depressing the left directional button 306a may have no effect on the current image, or a momentary indication on the display 302 may notify the user that the oldest captured image CI₁ is currently being displayed. In another embodiment, the oldest captured image CI₁ may be shifted toward the right to reveal the live view LV.

If, instead, the right directional button 306b is depressed, a currently-displayed captured image is shifted toward the left while the next newer captured image is shifted onto the display 302 from the right (operation 414), as shown in FIG. 5N. Presuming the most recently captured image CI_{N} is currently presented on the display 302, the most recently captured image CI_{N} is shifted toward the left, revealing the live view LV (operation 416), as illustrated in FIG. 50. In addition, such an action may override any programmed time period discussed above for display of the most recently captured image CI_{N}, resulting in an immediate shift of the most recently captured image CI_{N} from view. In another embodiment, the live view LV is shifted onto the display 302 from the right, as presented in FIG. 5P. If the live view LV is currently displayed while the right directional button 306b is depressed, the action may have no effect. In another embodiment, the user may be prompted via the display 302 or other means that the display 302 is currently showing the live view LV. In yet another implementation, the least recently captured image C₁ may be shifted in from the right to displace the live view LV.

In one embodiment, the processor 206 may be configured to allow the user to return to the live view LV directly from any of the captured images CI being presented on the display 302 in response to a user input (operation 418). In one embodiment, the user may initiate this action by depressing the shutter button 304. In another example, the user may instead utilize the up directional button 306c, the down directional button 306d, or the center button 306e of the five-button group 306.

While each of the embodiments discussed above involve shifting recently captured images to the left after capture, and then retrieving and shifting the images by way of the left directional button 306a and the right directional button 306b, other embodiments involving different directional reference frames are also possible. For example, newly captured images may be shifted to the right. In that case, the left directional button 306a and the right directional button 306b may again be employed to scan through the captured images CI. In another embodiment, the newly captured images may be shifted up or down, with the up directional button 306c and the down directional button 306d being utilized to review the images CI.

In the embodiments discussed herein, the processor 206 is configured to perform the shifting of the captured images CI onto and off of the display 302, as well as the presentation of the live view LV. To perform these tasks, the processor 206 may be controlled by software or firmware resident within the camera 300. Further, the software or firmware may take the form of a set of instructions stored within a storage medium within the camera 300, wherein the instructions may be executed by the processor 206 to perform the various tasks described herein. Also, the processor 206 may be one or more individual processors, possibly along with one or more electronic hardware elements, accomplishing these tasks.

Various embodiments of the invention, as described above, may provide several advantages. For example, some users may perceive the user interface described herein for viewing captured images and the live view as being intuitive. By shifting images onto and from a display in a particular direction, the user receives a visual cue as to which button or other portion of the user interface to activate to view the captured images or the live view. For example, if a captured image is shifted toward the left from view, the user may intuitively discern that actuating a left directional button will retrieve that image for display, without the benefit of a displayed prompt or a user manual.

Further, various embodiments employ portions of the user interface, such as directional buttons and the shutter button, which are already utilized for other purposes. Thus, a special mode button or switch, often used in digital cameras for viewing previously captured images, is not required, thus reducing the cost, size, and complexity of the associated digital camera.

While several embodiments of the invention have been discussed herein, other embodiments encompassed by the scope of the invention are possible. For example, while some embodiments of the invention are described above in reference to particular directions, such as left and right, for the shifting of images from the perspective of a user, other directions, such as up and down, may be employed in the alternative. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. A method for displaying a live view and captured images of a digital camera, the method comprising:
displaying the live view;
capturing a first image of the live view;
in response to capturing the first image, displaying the captured first image; and
after displaying the captured first image, shifting the captured first image from view toward a first direction to reveal the live view.

2. The method of claim 1, wherein displaying the captured first image continues for a predetermined time period before shifting the captured first image.

3. The method of claim 1, further comprising:
while displaying the live view, displaying a most recently captured image by shifting the most recently captured image into view from the first direction over the live view in response to a first user input.

4. The method of claim 3, wherein the first user input is a depression of a first directional button.

5. The method of claim 1, further comprising:
while displaying the live view, displaying a most recently captured image by shifting the most recently captured image into view from the first direction while shifting the live view toward a second direction from view in response to a first user input.

6. The method of claim 1, further comprising:
while displaying a most recently captured image, displaying the live view by shifting the most recently captured image from view toward the first direction to reveal the live view in response to a second user input.

7. The method of claim 6, wherein the second user input is a depression of a second directional button.

8. The method of claim 1, further comprising:
while displaying one of the captured images other than an oldest captured image, displaying a next, older captured image relative to the one of the captured images by shifting the next, older captured image into view from the first direction while shifting the one of the captured images toward a second direction from view in response to a first user input.

9. The method of claim 1, further comprising:
while displaying one of the captured images other than a most recently captured image, displaying a next, newer captured image relative to the one of the captured images by shifting the next, newer captured image into view from a second direction while shifting the one of the captured images from view toward the first direction in response to a second user input.

10. The method of claim 1, further comprising:
while displaying one of the captured images, displaying the live view in response to a third user input.

11. The method of claim 10, wherein the third user input is a depression of a shutter button.

12. A storage medium comprising instructions executable by a processor for implementing the method of claim 1.

13. A digital camera, comprising:
an imaging system configured to provide a live view, and to capture images of the live view;
a user interface comprising a display configured to present the live view and the captured images to a user; and
a processor configured to:
display the live view via the display;
capture a first image of the live view via the imaging system;
in response to capturing the first image, display the captured first image on the display; and
after displaying the captured first image, shift the captured first image toward a first direction off of the display to reveal the live view.

14. The digital camera of claim 13, wherein the processor is further configured to display the captured first image for a predetermined time period before shifting the captured first image.

15. The digital camera of claim 13, wherein:
the user interface further comprises a first user input indicator; and
the processor is further configured, when the live view is presented on the display, to display a most recently captured image on the display by shifting the most recently captured image into view from the first direction over the live view in response to an activation of the first user input indicator.

16. The digital camera of claim 15, wherein the first user input indicator is a first directional button.

17. The digital camera of claim 13, wherein:
the user interface further comprises a first user input indicator; and
the processor is further configured, when the live view is presented on the display, to display a most recently captured image on the display by shifting the most recently captured image into view from the first direction while shifting the live view toward a second direction from view in response to an activation of the first user input indicator.

18. The digital camera of claim 13, wherein:
the user interface further comprises a second user input indicator; and
the processor is further configured, while a most recently captured image is presented on the display, to display the live view on the display by shifting the most recently captured image from view toward the first direction to reveal the live view in response to an activation of the second user input indicator.

19. The digital camera of claim 18, wherein the second user input indicator is a second directional button.

20. The digital camera of claim 13, wherein:
the user interface further comprises a first user input indicator; and
the processor is further configured, while one of the captured images other than an oldest captured image is presented on the display, to display a next, older captured image on the display by shifting the next, older captured image into view from the first direction while shifting the one of the captured images from view toward a second direction in response to an activation of the first user input indicator.

21. The digital camera of claim 13, wherein:
the user interface further comprises a second user input indicator; and
the processor is further configured, while one of the captured images other than a most recently captured image is presented on the display, to display a next, newer captured image on the display by shifting the next, newer captured image from a second direction into view while shifting the one of the captured images toward the first direction from view in response to an activation of the second user input indicator.

22. The digital camera of claim 13, wherein:
the user interface further comprises a third user input indicator; and
the processor is further configured, while one of the captured images is presented on the display, to display the live view on the display in response to an activation of the third user input indicator.

23. The digital camera of claim 22, wherein the third user input indicator is a shutter button.

24. A digital camera, comprising:
means for providing a live view;
means for capturing images from the live view;
means for interfacing with a user, the interfacing means comprising a displaying means configured to display the live view and the captured images to the user; and
means for controlling the capturing means and the displaying means, the controlling means being configured to:
display the live view via the displaying means;
capture a first image of the live view via the capturing means;
in response to capturing the first image, display the captured first image via the displaying means; and
after displaying the captured first image, shift the captured first image toward a first direction off of the displaying means to reveal the live view.
